(19) United States
(12) Patent Application Publication
(10) Pub. No.: US 2022/0019726 A1
(43) Pub. Date: Jan. 20, 2022

(54) METHOD FOR GENERATING CONTENT IN AN EXTENSIBLE MANNER

(71) Applicant: THIDIMA SA, SION (CH)

(72) Inventor: Somanos SAR, SAVIGNY-SUR-ORGE (FR)

(21) Appl. No.: 17/294,275

(22) PCT Filed: Oct. 29, 2019
(86) PCT No.: PCT/EP2019/079470

§ 371 Date: May 14, 2021

(30) Foreign Application Priority Data
Nov. 15, 2018 (CH) 01416/18

(51) Int. Cl. G06F 40/143; G06F 16/957; H04L 29/08

(52) U.S. Cl. CPC G06F 40/143; H04L 67/02; G06F 16/9577

(57) ABSTRACT

A communication method for communicating information through a telecommunications network. The telecommunications network comprises includes at least one server and at least one terminal exchanging a dataset. The terminal is configured so as to implement an Internet browser and the communication method is executed by the Internet browser. The communication method includes a step of analysing said dataset, which consists of at least one element from among: an object element, a branch element and a display element.

### CROSS REFERENCE TO RELATED APPLICATIONS

This application is a National Stage of PCT Application No. PCT/EP2019/079470 filed on Oct. 29, 2019, which claims priority to Swiss Patent Application No. 01416/18 filed on Nov. 15, 2018, the contents each of which are incorporated herein by reference thereto.

### TECHNICAL FIELD

The field of the present invention concerns that of communication methods. It concerns particularly, but not exclusively, the field of website technologies operating under the norms and standards of 3WC.

### BACKGROUND

Nowadays, some programs require an outer module («plugin») to be installed on a web browser in order to be able to process content allowing the manipulation of vector graphics, raster images and «ActionScript» scripts with a view to create multimedia content such as animations, videos, games, applications, among others, intended to be published on the Internet.

Nonetheless, these programs increasingly present many interoperability as well as security issues, due to this very need for a plugin.

Moreover, the rendering of web pages is carried out by a remote server. This implies for each website the implementation of an infrastructure which must then be operated, secured, maintained, etc. In addition, this approach generates a significant cost for the site operator, since the computing time of each page is charged to the server.

In addition, almost all languages, the instruction set is limited to a set of keywords, or reserved. For example, in HTML there is a list of «tags» recognized by the browser. Users cannot add a new tag meeting their own needs without allowing the user to extend its «dictionary», that is to say to add new objects to the base library, available in the renderer.

Finally, based on the document object model (abbreviated «DOM»), an Internet browser can only display content described by HTML, which is a declarative language, and therefore completely static. To make the same content more appealing, the browser also uses CSS, which allows for very rich and sophisticated skin. But always more or less static skin. The dynamic side is only made possible by the presence of JavaScript.

Basically, because the web browser is DOM based and it relies on HTML, HTML generation is always done on the server side. The browser is therefore content to be connect to the server to receive HTML, before displaying it, to decorate it with CSS and possibly to make it more or less dynamic with JavaScript code. Even in the most modern architectures with very dynamic content, it is still the server that generates the pages, always in HTML.

Therefore, it is necessary to find a solution which does not require a plugin while respecting the HTMLS and WebGL norms implemented by the browser editors, in the form of an extensible language so as to extend the intrinsic capacities of the «Virtual Reality Modeling Language» and namely «VRML» for short, thus increasing the power and richness of applications using VRML.

### BRIEF SUMMARY

The object of the present invention is to resolve all or part of the drawbacks mentioned above in the form of a method for communicating information through a telecommunications network, the telecommunications network comprising at least one server and at least one terminal exchanging a set of data; said at least one terminal being configured to implement an internet browser; the communication method being executed by the internet browser and comprising a step of analyzing said set of data; the set of data consisting of at least one among: an object element, a branch element and a display element;
the object element being configured to be unique when it is generated;
the branch element being configured to comprise at least one auxiliary branch element and/or at least one terminal branch element; and,
the display element being configured to create a graphical representation.

Thus, by virtue of this arrangement, the communication method makes it possible to completely disregard the three languages. The communication method makes it possible to render the page locally, on the internet browser, by the internet browser, instead of having it done by remote servers. Among other things, it allows the page to be edited in WYSIWYG mode. The communication method provides a dynamic and extensible web page description format. It makes it possible to ignore the technical layer defined by 3WC, which is complex to be mastered and implemented. The communication method therefore combines the richness and power of the CSS/HTLM/Javascrpit triptych.

According to one embodiment, said set of data is received by said at least one terminal from said server.

According to one embodiment, the communication method comprises a step of generating an HTML markup language from said set of data by the internet browser to represent at least one web page.

Thus, thanks to this arrangement, a modern web page can be described in an autonomous, modular and portable manner, so as to allow its generation in the three languages understandable by the browser: CSS, HTML and Javascript. In addition, in a typical diagram, this set of data must first be assembled in a specific order and hierarchy by the server before being sent to web browsers for display. Thanks to this method, this is no longer necessary.

According to one embodiment, the communication method comprises a step of forming a tree from said set of data.

According to one embodiment, said at least one auxiliary branch element is configured to comprise said at least one terminal branch element.

According to one embodiment, the step of forming said tree comprises a step of executing the display element.

According to one embodiment, the step of forming a tree comprises a step of executing the object element.

Other characteristics and advantages of the invention will appear better on reading the following description of an embodiment of the invention given by way of non-limiting example.

### BRIEF DESCRIPTION OF THE DRAWINGS

The invention will be better understood from the detailed description which is set out below with regard to the drawing, in which:

FIG. 1 represents an example of the architecture of a telecommunications network in which the method according to the invention is implemented;

FIG. 2 shows an example of a flowchart showing the steps of the information communication method according to the invention is implemented; and,

FIGS. 3A-3D illustrate an example of set of data and generation of an HTML markup language S760 by the web browser according to one embodiment.

### DETAILED DESCRIPTION

In the following detailed description of the figures defined above, the same elements or elements fulfilling identical functions may retain the same references so as to simplify the understanding of the invention.

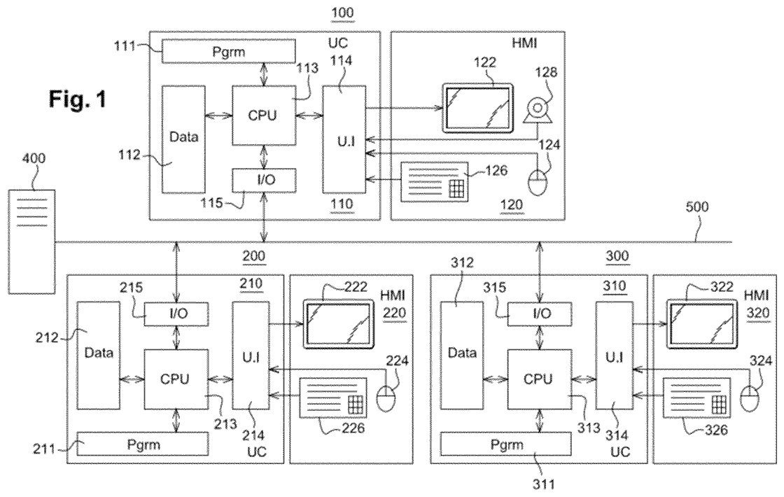

According to one embodiment represented in FIG. 1, the telecommunications network 500 can be a conventional telecommunications link network, called wired, for example routers, modems and/or switch or wireless, for example a Wi-Fi™ network and/or a GSM™ network. The telecommunication network can be a local, intranet and/or internet network configured so that messages can be transmitted to at least two terminals connected to the telecommunication network, through multiple links and/or link nodes. The terminals 100, 200 and/or 300 can be of the same or different type, they are typically computers connected to a local network, to an intranet network and/or to a telecommunications network 500, connected mobile telephones and/or tablets connected to a GSM™ network and/or to a Wi-Fi™ network, or any telecommunication device connected to an interaction means and having an acquisition means. FIG. 1 shows an example of a network with a group of terminals. Such terminals include at least one central unit 110. The central unit 110 comprises at least one program module 111, a storage means 112 which can be materialized by a hard disk for example, a connection means 115 allowing the communication of a terminal with the telecommunications network 500, this connection means is managed by a program module 111 stored in the memory of the latter.

The terminal 100 has a Human/Machine 120 interaction means—«Human Machine Interface». The interaction means 120 may for example comprise a screen 122, a mouse 124, a keyboard 126 and/or a camera 128. For reasons of clarity, it is assumed that the terminals 200 and 300 also have interaction means quite similar in their functions.

The keyboard 126 includes keys allowing to enter a message with alphanumeric characters which, in the form of a character string, constitute a message. The keyboard 126 can be deported or integrated in the terminal and/or in the interaction means, this is the case for example if the terminal is a mobile telephone, likewise the keyboard 126 can be tactile, thus offering the possibility of display icons directly on the screen 122 that the user can select with the aid of touch actions directly on the interaction means or by means of a mouse 124, if the latter is available. Entering a message can also be done using a voice recognition system or motion recognition through a camera 128 with a built-in microphone (not represented). The screen 122 can also be deported or integrated into the terminal. The management of the screen 122, the mouse, the keyboard 126 and the camera 128 is done by a device manager 114.

The interaction means in particular the screen makes it possible to display messages from other terminals but also messages generated by the terminal itself such as menus, for example. These menus can appear on the screen or in a window that occupies only part of the screen. The generation of menus is integrated into the e-mail program that the user selects using an application browser. The device manager 114 outputs video signals to the display 122 and receives data entered by the user on the keyboard 126.

The server 400 manages the network and establishes rules by which the computers communicate and cooperate by, for example, allowing the sharing and/or the exchange of set of datas 799 between different terminals. After having detailed the different components of a telecommunications network, the steps of the method will now be explained.

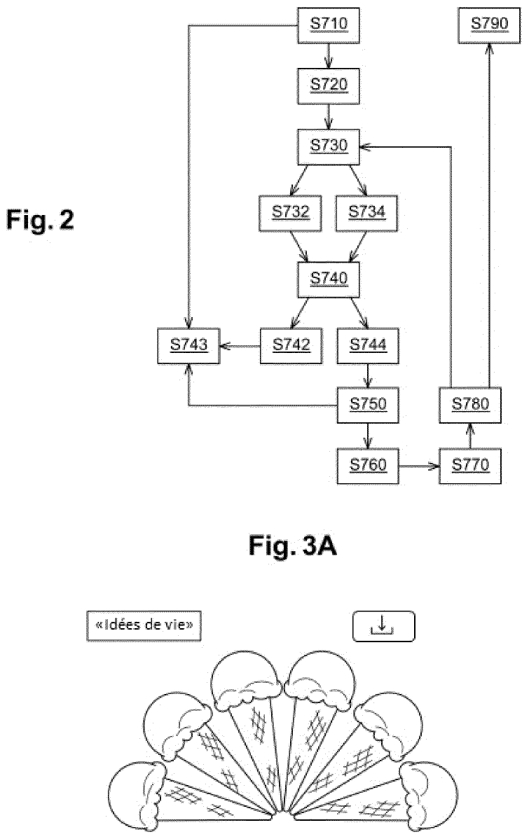

The S700 information communication method of the present invention allows an exchange of set of data 799 through a telecommunication network 500, as represented in FIG. 2. This telecommunication network 500 comprises at least one server and at least one terminal both exchanging a set of data 799. This set of data 799 consists of at least one element from: an object element 710, a branch element 720 and a display element 730. Nonetheless, the set of data 799 necessarily comprises the object element 710, while the branch element 720 and/or the display element 730 is optional or may be optional.

The object element 710, also called «kind» is configured to be unique when it is generated, it is an attribute which makes it possible to associate an informational content with a dynamic object, that is to say a javascript code designed to present content the way you want it to. This is because object element 710 is a unique string of characters in the namespace of the renderer.

Indeed, when we have an object described as:
object element 710: «note»
content: «LETC»
style:
color: «Red»
font size: «16 px»

The dynamic object associated with the object element 710 «note» will display on the screen the text «LETC» in red and of size 16 pixels. But we can just as easily extend or overload this dynamic object for anyone else, for example launching a voice synthesis on the word.

According to one embodiment, the object element 710 creates a new dynamic object, for example:
object element 710: «play»
content: «LETC»
style:
color: «Red»
font size: «16 px»

And define the expected behavior via the associated dynamic object. For example, underline possible palindromes in the text.

According to another example based on an airplane flight plan, the object element 710, although unique, it can allow different interpretations:
object element 710: «plot»
name: «F-GAMA»
Start: «LFOX»
Arrival: «VDPP»

In this example, the set of data is accessible to any authorized person: customs, airlines, alert and rescue services, the army, air traffic control services, etc.

This is the same set of data 799, available on the same infrastructure. And yet, each profession needs to treat it differently, according to its own constraints. In a classic scheme, it would be appropriate to create as many infrastructures as there are trades. However, with the communication method S700 of the present application, it suffices to create the dynamic object attached to the business.

The branch element 720, for its part, is also called «kids» and is configured to comprise at least one auxiliary branch element 721 and at least one terminal branch element 722 or at least one terminal branch element 722. Indeed, according to an embodiment, the auxiliary branch element 721 may comprise at least one terminal branch element 722 or another auxiliary branch element 721 recursively. Nonetheless, a terminal branch element 722 cannot contain other terminal branch elements 722.

Also, one of the advantages of this communication method S700 is that there is no limit to the number of object elements 710 since they are unique in the same branch element 720.

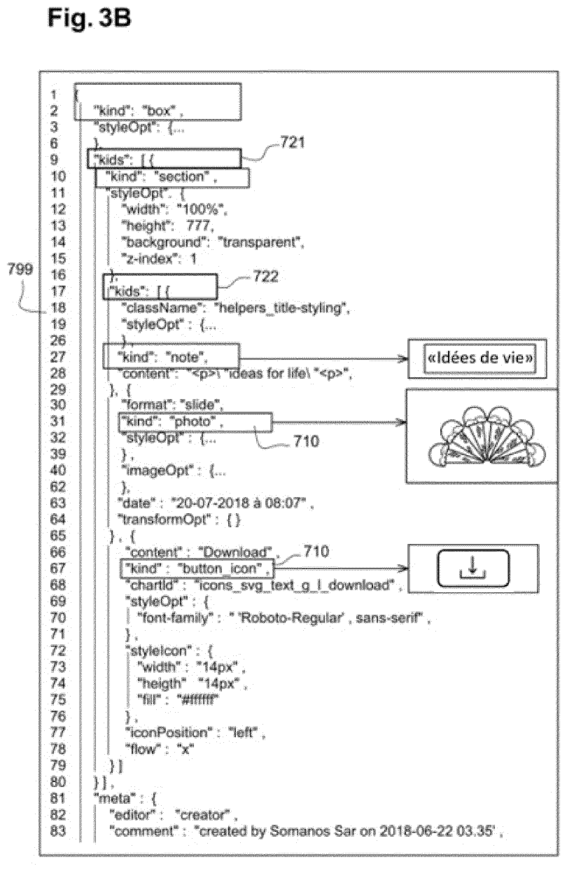

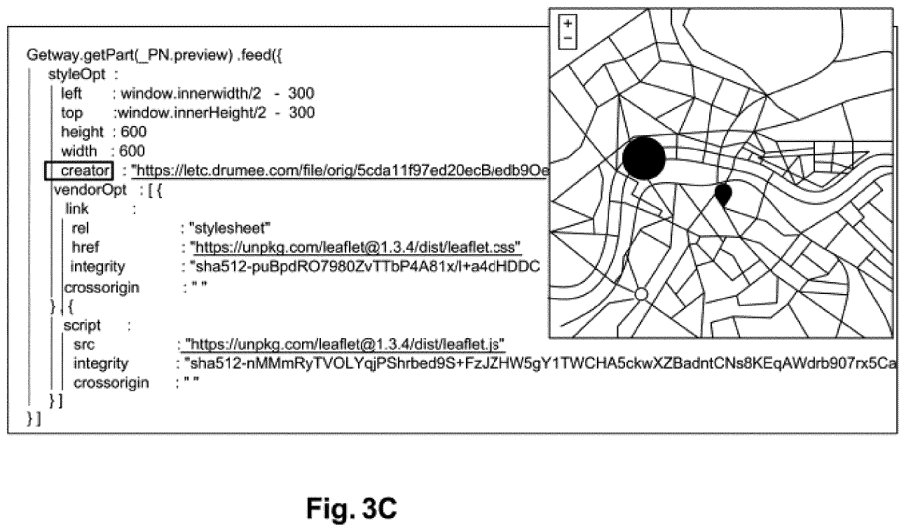

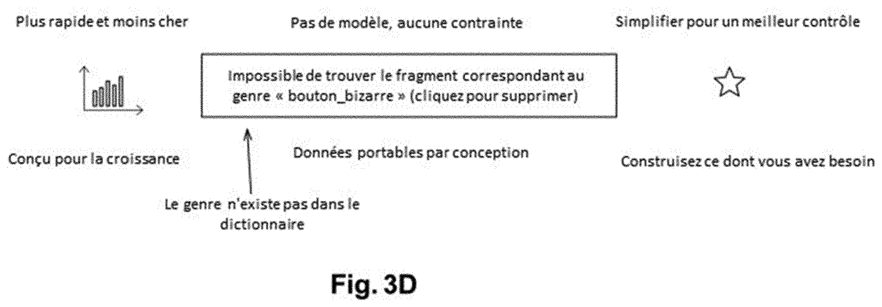

In the example of FIGS. 3A and 3B, the set of data consists of an auxiliary branch element 721 of the «box» species which in turn contains another auxiliary branch element 721 of the «section» species which contains three branch 720 terminal elements, of three different species: «note», «photo» and «button».

The display elements 740, also called «creator» and represented in FIG. 3C, of all these species are internal, that is to say that the codes capable of creating the graphics are already present in the basic dictionary of the internet browser.

The terminal is configured to run an internet browser and the communication method S700 is executed by the internet browser. When this communication method S700 is executed, various steps are implemented.

In general, web browsers can only comprise the three basic languages CSS, HTML and Javascript. The communication method S700 of the present invention makes it possible to personalize, associate a type of content with a specific and extensible behavior.

In fact, the HTML is no longer generated by the server but locally, by the internet browser itself, via, in part, by its renderer encoded in Javascript.

One of the method steps is the step of analyzing S710 the set of data 799. Following this step of analyzing S710 the set of data 799, there follows a step of forming the tree S720 which comprises a step of executing the display element S730 and/or a step of executing the object element S740.

Thanks to this tree structure, it is therefore possible to arrange the presentation of multimedia content as desired from the set of data 799.

In this step of executing display element S730, the communication method checks whether the display element 730 can be internal or external. In the case of an external display element 730, that is to say, in the step of executing the external display element S734, the display element 730 should specify how the renderer can find it. Concretely, this is done through the presence of a unified URL resource localization scheme.

When the display element 730 is internal, that is to say, during the step of executing the internal display element S732, it means that the display element 730 contains no value. In this case, it is the renderer can, for example, find the code of the display element 730 in its base dictionary, which is an associative table relating the species of the object element 710 to the code of the display element 730.

Finally, whether during the step of executing internal display element S732 or during the step of executing external display element S734, the display element 730 is configured to create a graphical representation. Indeed, an object must have one and only one display element 730. The display element 730 is a small program whose role is to create a visual representation of the object, in the tree hierarchy of the page.

Once the display element has been found and executed, a step of executing the object element S740 follows, in which the communication method checks whether the object element 710 comprises a code extract «snippet» which will be executed.

In the case where the object element 710 does not comprise a snippet, as in FIG. 3D, the communication method recognizes the absence of the snippet during a step of recognizing the absence of the snippet S742 and an error message will be generated during a step of generating an error message S743. Otherwise, if the object element 710 comprises a snippet (not represented), the communication method keeps the snippet in memory during a step of saving the snippet of the object element S744 before being executed during a step of executing the snippet S750.

If the step of executing the snippet S750 includes errors, an error message will be generated during a step of generating an error message S743. Conversely, the communication method S700 will perform a step of generating an HTML markup language S760 by the web browser to represent at least one element of the DOM.

Indeed, thanks to this step, the internet browser can display content described by the HTML language while respecting its position in its place in the tree formed during a step of inserting an HTML markup language S770.

Indeed, internet browsers are based on the DOM and it relies on HTML, HTML generation is always done on the server side but never on the user side namely by the internet browser. Thanks to this communication method, the internet browser no longer just connects to the server to receive HTML, before displaying it, decorating it with CSS and possibly making it more or less dynamic with JavaScript code, since it is able to generate by and for itself the desired content, specified by 710.

Following this step of inserting the HTML markup language S770, the communication method continues reading the tree formed during a reading step S780 which returns either to the step of executing the display element S730 or ends the rendering of the web page by generating during a step of generating a final rendering message S790.

Thus, thanks to this arrangement, the communication method S700 makes it possible to read a web page description language which makes it possible to completely disregard the three languages CSS/HTML/Javascript. The communication method S700 also makes it possible to render the page locally, on the internet browser, by the internet browser, instead of having it done by remote servers. Among other things, it allows the page to be edited in WYSIWYG mode. The communication method S700 provides a dynamic and extensible web page description format. It makes it possible to ignore the technical layer defined by 3WC, which is complex to be mastered and implemented. The communication method S700 therefore combines the richness and power of the CSS/HTLM/Javascrpit triptych.

In addition, the communication method S700 uses the JSON data format. Thus, the volume of the set of data 799 to be transferred is also reduced, compared to a scheme where the whole page is transferred in HTML, which also helps reduce the consumption of bandwidth on the one hand.

In addition, by design, the set of data 799 is entirely semantic, since the presence of the dictionary allows to know with precision the nature of each object defined by its «kind» attribute, as well as its other qualifying attributes (color, size, etc.); descriptions (comments, authors, location, etc.) or other metadata that the JSON format allows.

Based on the JSON format, the communication method S700 enables a dynamic and extensible multimedia content description format to be read. It is particularly suitable for editing web pages in WYSIWYG mode, thanks to a self-describing architecture.

The communication method S700 makes it possible to completely disregard the technical layer defined by 3WC, which is very complex to be mastered and implemented. In other words, it combines the richness and power of the CSS/HTLM/Javascrpit triptych with the advantages of JSON, compact, light, autonomous, both understandable by users and by machines. This combination makes web pages «portable».

Indeed, a modern web page is built using three different languages to obtain a hierarchical document either HTML, decorative, CSS and interactive language, or JavaScript language. This offers a power and a richness of presentation. However, the use of three different languages to achieve this objective implies a very complicated implementation, especially when it comes to editing such content in WYSIWYG mode, while the communication method S700 combines the three languages in only one, while preserving the limitless character of the combination of the three basic languages.

Finally, another advantage of the communication method S700 is a fluidity in the sharing of data, so as to process them collaboratively. Indeed, with the same set of data 799, it is possible to associate several views, each specific to a particular role, such as the example given for the airplane plan.

1. A method for communicating information through a telecommunications network, the telecommunications network comprising at least one server and at least one terminal exchanging a set of data; said at least one terminal being configured to implement an internet browser; the communication method being executed by the internet browser and comprising a step of analyzing said set of data; the set of data consisting of at least one among: an object element, a branch element and a display element;
the object element being configured to be unique when it is generated;
the branch element being configured to comprise at least one auxiliary branch element and/or at least one terminal branch element; and,
the display element being configured to create a graphic representation.

2. The communication method according to claim 1, wherein said set of data is received by said at least one terminal from said server, during a reception step.

3. The communication method according to claim 1, which comprises a step of forming a tree from said set of data.

4. The communication method according to claim 3, wherein said at least one auxiliary branch element is configured to comprise said at least one terminal branch element.

5. The communication method according to claim 4, wherein the step of forming said tree comprises a step of executing the display element.

6. The communication method according to claim 3, wherein the step of forming said tree comprises a step of executing the object element.

7. The communication method according to claim 1, which comprises a step of generating an HTML markup language from said set of data by the internet browser to represent at least one web page.

8. The communication method according to claim 2, which comprises a step of forming a tree from said set of data.

9. The communication method according to claim 8, wherein said at least one auxiliary branch element is configured to comprise said at least one terminal branch element.

10. The communication method according to claim 9, wherein the step of forming said tree comprises a step of executing the display element.

11. The communication method according to claim 10, wherein the step of forming said tree comprises a step of executing the object element.

12. The communication method according to claim 11, which comprises a step of generating an HTML markup language from said set of data by the internet browser to represent at least one web page.

13. The communication method according to claim 4, wherein the step of forming said tree comprises a step of executing the object element.

14. The communication method according to claim 5, wherein the step of forming said tree comprises a step of executing the object element.

15. The communication method according to claim 8, wherein the step of forming said tree comprises a step of executing the object element.

16. The communication method according to claim 2, which comprises a step of generating an HTML markup language from said set of data by the internet browser to represent at least one web page.

17. The communication method according to claim 3, which comprises a step of generating an HTML markup language from said set of data by the internet browser to represent at least one web page.

18. The communication method according to claim 4, which comprises a step of generating an HTML markup language from said set of data by the internet browser to represent at least one web page.

19. The communication method according to claim 5, which comprises a step of generating an HTML markup language from said set of data by the internet browser to represent at least one web page.

20. The communication method according to claim 6, which comprises a step of generating an HTML markup language from said set of data by the internet browser to represent at least one web page.
